(19) United States
(12) Patent Application Publication
(10) Pub. No.: US 2007/0225988 A1
(43) Pub. Date: Sep. 27, 2007

(54) Method designed for international students or candidates in the United States to search for employers who may be receptive to their candidacy and search current Job opportunities or postings from these employers

(76) Inventor: Vivek Bapat, Pittsburgh, PA (US)

Correspondence Address: VIVEK BAPAT, 1207 PINEWOOD STREET, PITTSBURGH, PA, 15243, US

(21) Appl. No.: 11/277,266

(22) Filed: Mar. 23, 2006

(51) Int. Cl. G06Q 10/00; G06Q 30/00

(52) U.S. Cl. 705/1

(57) ABSTRACT

The invention is based on internet search, commercially and publicly available databases, and uses commercially available RSS/XML technology. By combining two hitherto disconnected searches typically used by international candidates, the method provides a sequential and single process that international candidates can use to pinpoint employment opportunities in the United States. The invention could be used in commercial settings where selective search of historical records is used to pinpoint existing information based on selective application or criteria.

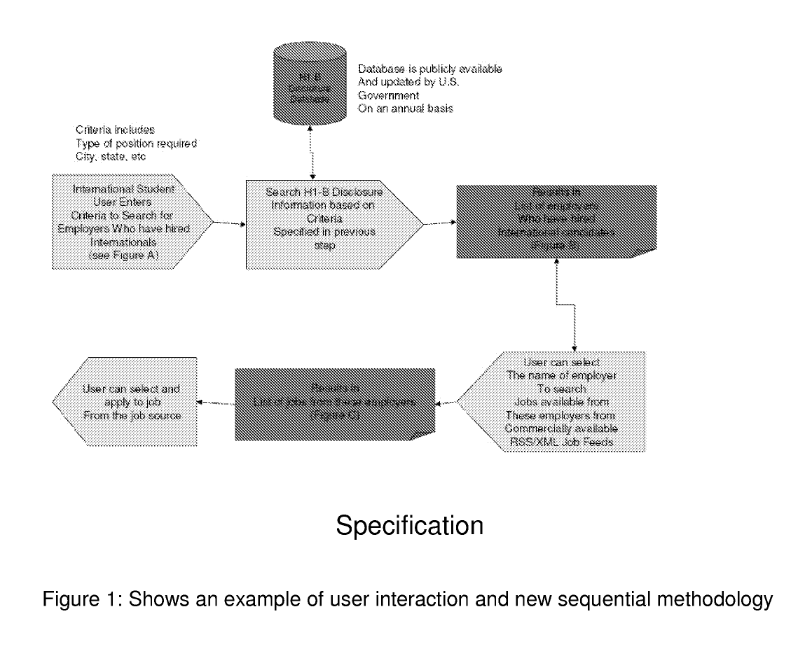

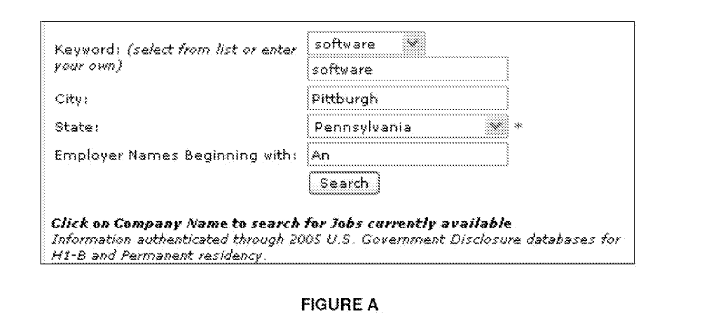

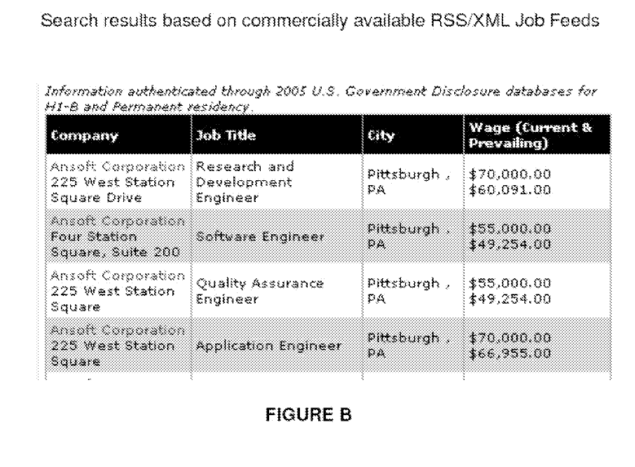

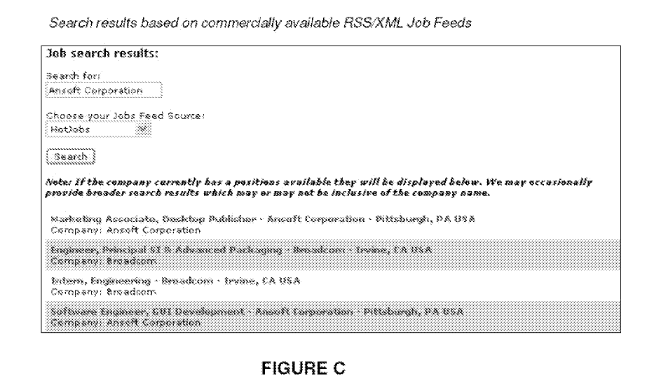

### SPECIFICATION

The method combines the use of historical H1-B temporary visa and permanent employment disclosure records published annually by the United States government with commercially available RSS/XML job feeds across the internet. International candidates can use this new internet based sequential methodology for the first time to specify criteria to help identify employers who have hired international candidates in the past, and then search for jobs currently available from those employers in two easy steps.

What is claimed is:

1. A methodology that uses a keyword or criteria based search on a publicly available H1-B temporary visa and permanent residency published annually by the United States Government to identify U.S. Employers who have hired international candidates in the past. Once such employers are identified, the methodology uses RSS/XML (RSS—Really Simple Syndication, XML—Extensible Mark up Language) to help the user list current job advertised by the company in commercially available RSS/XML job feeds.
